(19) United States
(12) Patent Application Publication
(10) Pub. No.: US 2007/0157777 A1
(43) Pub. Date: Jul. 12, 2007

(54) Device and method for preparing a piece of adhesive tape of desired length from a reel

(75) Inventor: Pierre Talou, Cremieu (FR)

Correspondence Address: OLIFF & BERRIDGE, PLC, P.O. BOX 19928, ALEXANDRIA, VA, 22320, US

(73) Assignee: CEFMA, Genas (FR)

(21) Appl. No.: 11/646,562

(22) Filed: Dec. 28, 2006

(30) Foreign Application Priority Data
Jan. 11, 2006 (FR) 06/00230

(51) Int. Cl. B26D 7/06; B26D 1/00

(52) U.S. Cl. 83/23; 83/13; 83/78; 83/151

(57) ABSTRACT

A gripper which can hold the adhesive tape between its branches is mounted on a chain driven in a loop.

In a gripping area at the start of the outgoing portion, the gripper is closed around the adhesive tape unwound from the reel. The gripper which is kept closed is then moved along the outgoing portion, thus pulling the adhesive tape up to a release area where it is stopped.

The adhesive tape is then cut across by a cutting system designed to hold the adhesive tape on both the upstream and the downstream sides. The gripper is then opened, and the cut piece is transferred to a user station.

The gripper is then returned to the gripping area by driving the chain.

### BACKGROUND OF THE INVENTION

The present invention relates to a device and a method for preparing a piece of adhesive tape of desired length from a reel of adhesive tape.

Such a piece of adhesive tape is intended to be supplied equally effectively, according to the desired application, either to a machine for affixing pack carrying handles or to a batching machine.

### DESCRIPTION OF THE PRIOR ART

In the case of machines for affixing handles, a piece of adhesive tape is applied to a bundle of bottles or bricks, around the width or the length, according to requirements. The ends of the piece are bonded on either side of the pack, while the intermediate part acts as a loop for gripping. To prevent the loop from being adhesive, in this area the piece of adhesive tape has either an applied card label or a non-adhesive plasticized insert incorporated directly into the adhesive tape, which in this case is called a “prepared handle”.

In the case of batching machines, one or more pieces of adhesive tape are applied to a set of unitary products to fix them together and form a batch.

For both of these types of machines, the length and width of the adhesive tape can vary according to the type of product to be treated. It is therefore generally necessary, according to requirements, either to use a plurality of separate devices for preparing pieces of adhesive tape, or to carry out adjustments which are often difficult and complicated on a single device. Additionally, in the case of non-uniform adhesive tapes, for example those carrying text or patterns, or in the case of prepared handles, it is essential that the length to which the piece is cut should be completely determined and reproducible, to ensure the correct positioning of the text or the plasticized insert on the different pieces which are successively prepared.

### SUMMARY OF THE INVENTION

The invention is intended to improve the devices and methods for preparing pieces of adhesive tape.

In a first aspect, the invention relates to a device for preparing a piece of adhesive tape of desired length from a reel of adhesive tape, the device comprising:

at least one endless conveying means, of the belt, chain or equivalent type, having an outgoing portion and a return portion, and capable of being driven in a loop by drive means;

at least one gripper mounted on the endless conveying means, having two branches, and being capable of taking up an open position, in which the branches are separated from each other, or a closed position, in which the branches are substantially adjacent and capable of holding the adhesive tape between them;

means for causing the closure of the gripper when the latter is located on the outgoing portion in a gripping area, so that the gripper can hold the adhesive tape unwound from the reel;

means for holding the gripper in the closed position when it moves on the outgoing portion, to enable the adhesive tape to be pulled substantially parallel to the outgoing portion;

means for causing the stopping of the endless conveying means when the gripper is located on the outgoing portion in a release area located downstream of the gripping area;
means for causing the opening of the gripper when the latter is located in said release area;

a cross-cutting system for the adhesive tape, located in the vicinity of the outgoing portion, downstream of the gripping area, and designed to be capable of holding the adhesive tape once the latter has been cut off, at least on the upstream side of the cutting system.

Thus, by means of the device according to the invention, it is possible to fix the gripping area but to position the release area in the desired location on the outgoing portion, according to the length of the desired piece of adhesive tape. This adjustment does not require any complicated structural modification. Furthermore, since the adhesive tape cutting system enables this tape to be held once it has been cut off on the upstream side, it is unnecessary to provide a second gripper which would hold the tape upstream, and would be spaced apart from the first gripper by a specified distance. On the contrary, even with a single gripper, it is possible to bring this gripper toward the gripping area for the subsequent pulling of another piece of adhesive tape, while the prepared piece is transferred towards a user station.

In a possible embodiment, the device comprises a fixed cam positioned facing the outgoing portion to cause the closure of the gripper in the gripping area and hold the gripper in the closed position over the whole length of said fixed cam, and a moving cam extending as a continuation of the fixed cam facing the outgoing portion, at least up to the release area, said moving cam being movable between a forward position, in which it holds the gripper in the closed position, and a retracted position, in which it allows the gripper to move to the open position. Thus it is possible to make the gripper open at any point in line with the moving cam, which provides a large degree of freedom in respect of the length of the resulting piece of adhesive tape without requiring significant structural modifications of the device.

Preferably, the gripper comprises resilient means positioned to push the branches of said gripper toward the open position and at least one roller which can interact with the fixed and moving cams to enable the gripper to close in opposition to said resilient means.

The device can have at least two grippers mounted on the endless conveying means, in such a way as to be substantially regularly distributed on the periphery of said endless conveying means. This makes it possible to reduce the time taken for a gripper to reach the gripping area when the piece has been cut off, since it is not necessary for the gripper which has just pulled the adhesive tape to move from the release area toward the gripping area by passing, for example, along the whole of the return portion. Thus it is possible to have, for example, 2, 3, 4 or 5 grippers.

For example, the gripper is mounted on the endless conveying means in such a way that, when it pulls the adhesive tape, the latter is located in a plane substantially parallel to the plane of the endless conveying means.

In a possible embodiment, the device comprises two endless conveying means which are substantially identical, parallel and superimposed, and are driven by the same drive means, the gripper being fixed to the two endless conveying means.

Advantageously, the cutting system is designed to hold the cut piece of adhesive tape on the downstream side of the cutting system. Thus, on the one hand, the adhesive tape is held on the reel side, and, on the other hand, the cut piece is held at its two ends, by the cutting system and by the gripper located in the release area, on which the piece is stuck. Consequently, gravity has no effect on the movement of the piece, and the device can be placed in any position in space.

Additionally, the cutting system can comprise:

a cutting unit positioned on one side of the plane of the pulled adhesive tape, having a cross-cutting tool upstream and downstream of which pressure elements are positioned;

an anvil unit positioned on the other side of the plane of the pulled adhesive tape, having an upstream finger and a downstream finger spaced apart from each other and located so that they face the pressure elements of the cutting unit; the units being movable between:

a forward position, in which the cutting tool is engaged in the space provided between the upstream and downstream fingers of the anvil unit, and the adhesive tape, when cut off, can be held between said fingers and the pressure elements of the cutting unit;

and a retracted position, in which the units are separated from each other and from the plane of the pulled adhesive tape, so as to enable the gripper to move on the outgoing portion.

In a second aspect, the invention relates to a method for preparing a piece of adhesive tape of desired length from a reel of adhesive tape, comprising the steps of:

providing at least one endless conveying means, of the belt, chain or equivalent type, having an outgoing portion and a return portion, and capable of being driven in a loop by drive means;

providing at least one gripper mounted on the endless conveying means, having two branches, and being capable of taking up an open position, in which the branches are separated from each other, or a closed position, in which the branches are substantially adjacent and capable of holding the adhesive tape between them;

providing a system for cross-cutting the adhesive tape, located in the vicinity of the outgoing portion, downstream of the reel;

causing the closure of the gripper when the latter is located on the outgoing portion in a gripping area located upstream of the cutting system, so that the gripper can hold the adhesive tape unwound from the reel;

driving the endless conveying means, in order to move the gripper which is kept closed on the outgoing portion, and consequently to pull the adhesive tape substantially parallel to the outgoing portion;

detecting the fact that the adhesive tape has been pulled to the desired length and causing the gripper to stop in the corresponding position, in a release area located on the outgoing portion;

cutting the adhesive tape with the cutting system, and holding the adhesive tape cut in this way at least on the upstream side of the cutting system;

transferring the piece of adhesive tape prepared in this way toward a user station;

driving the endless conveying means, in order to return the gripper to the gripping area.

### BRIEF DESCRIPTION OF THE DRAWINGS

A possible embodiment of the invention will now be described, by way of example and without restrictive intent, with reference to the attached figures.

FIGS. 1 and 2 are a front view and a plan view respectively of the grippers mounted on two chains of the device according to the invention;

FIGS. 3 and 4 are a front view and a plan view respectively of the whole device according to the invention;

FIG. 5 is a side view of the device according to the invention, additionally showing a device for transferring the prepared piece of adhesive tape;

FIGS. 6 and 7 are side views of a gripper, in an open position and in a closed position respectively;

FIGS. 8 and 9 are plan views of a gripper, in an open position and in a closed position respectively;

FIG. 10 is a front view of the anvil unit;

FIGS. 11a and 11b are plan views of the anvil unit and the cutting unit respectively;

FIGS. 12a and 12b are side views of the anvil unit and the cutting unit respectively, and

FIG. 13 is a plan view of the whole device according to the invention, additionally showing a device for transferring the prepared piece of adhesive tape and a system for unwinding the adhesive tape from the reel.

### DESCRIPTION OF THE PREFERRED EMBODIMENTS

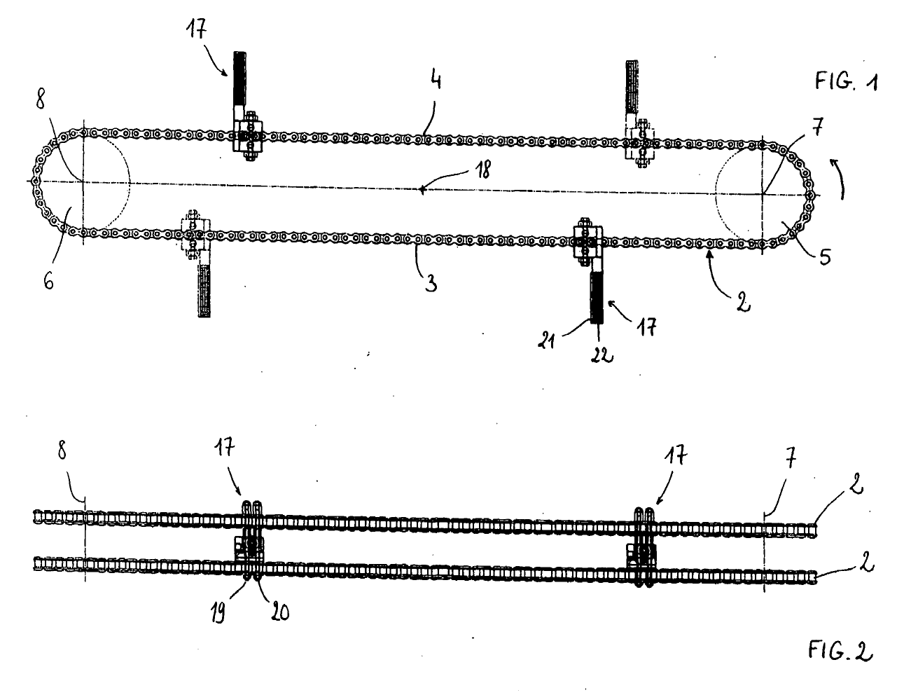

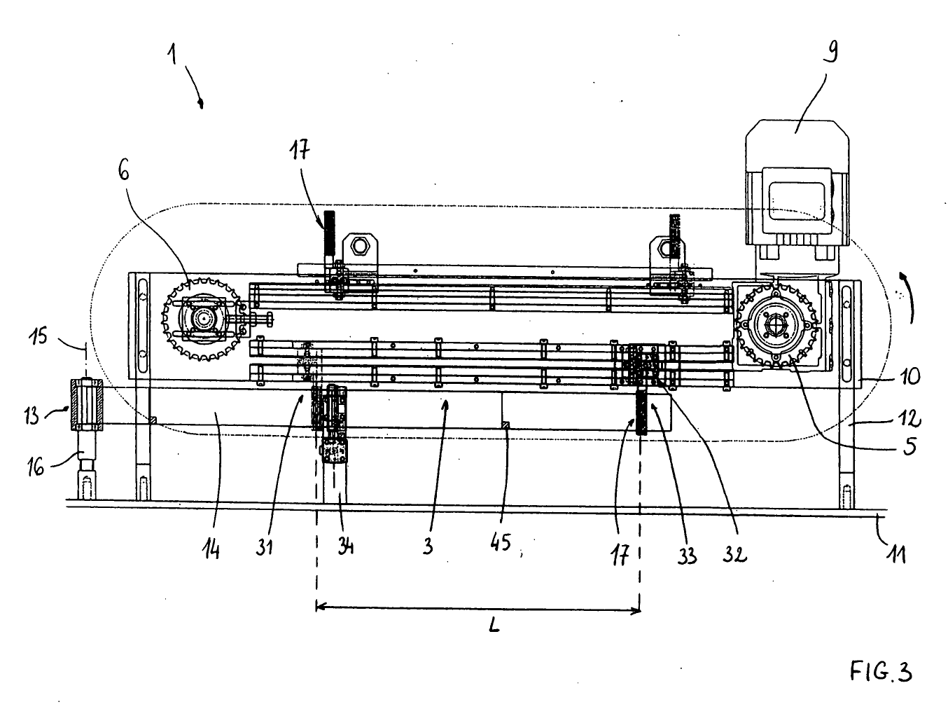

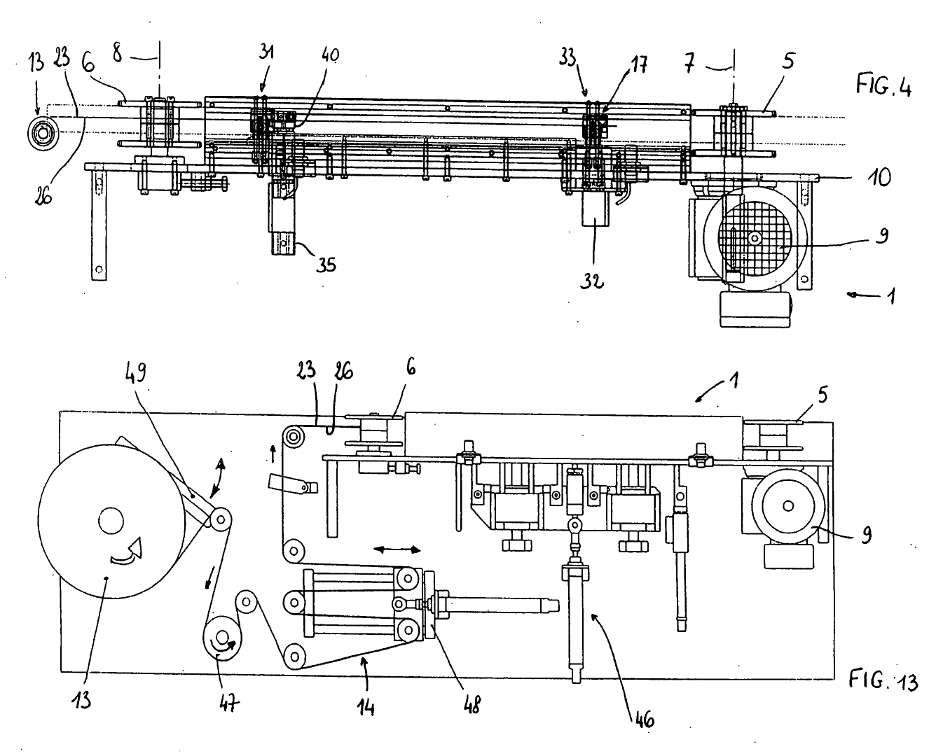

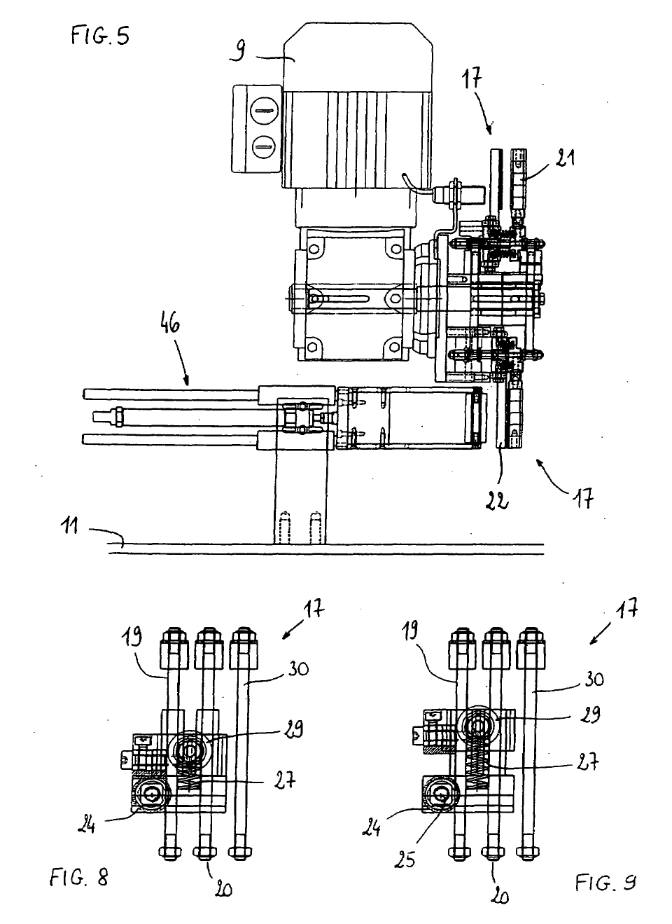

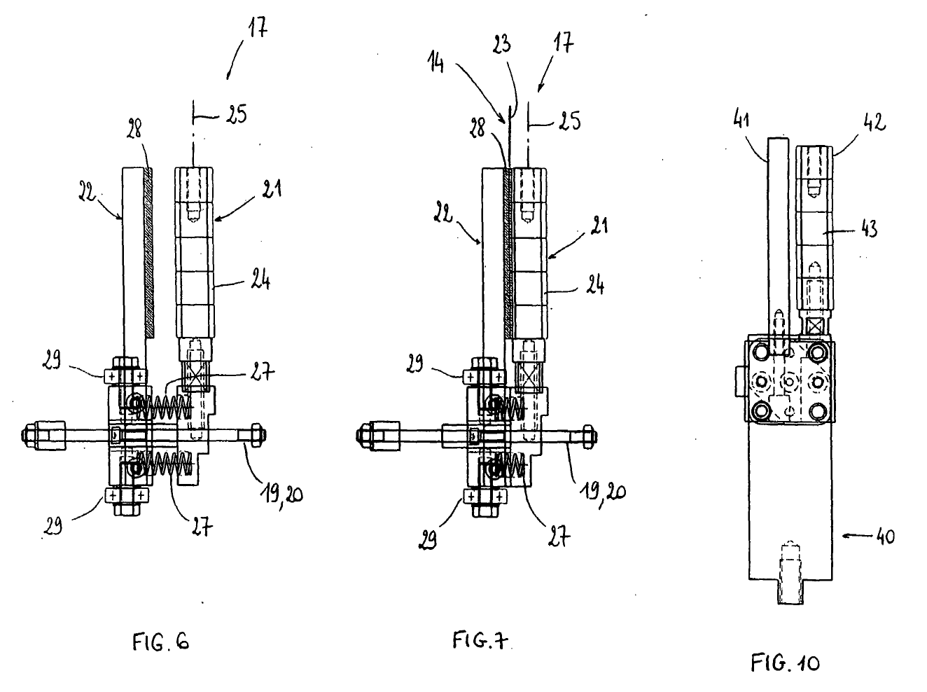

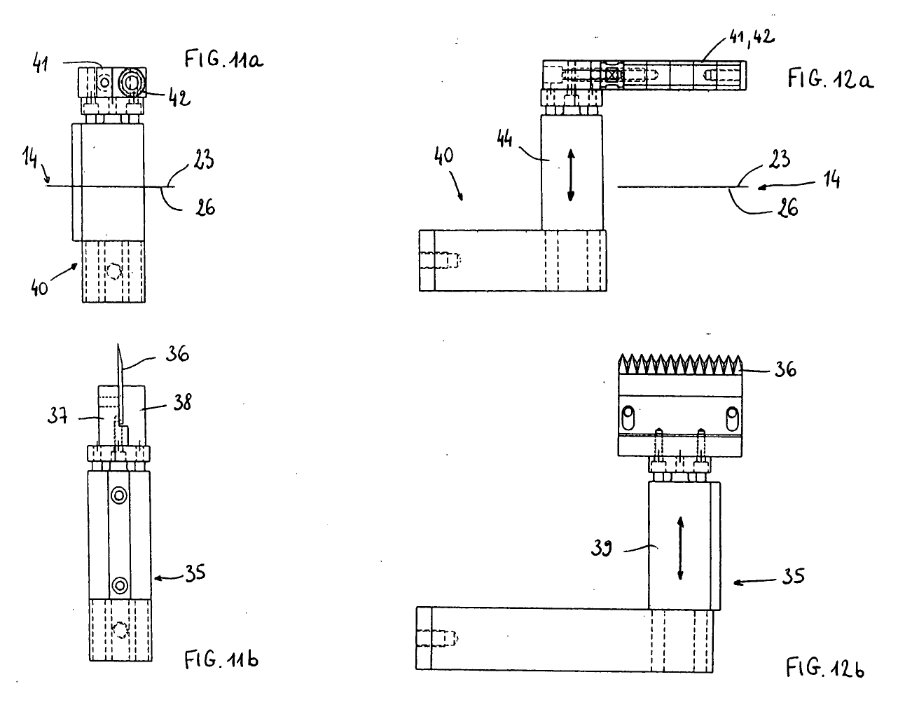

The device 1 for preparing a piece of adhesive tape comprises, in the first place, two chains 2 which are substantially identical, parallel and superimposed. Each chain 2 forms a flat loop comprising an outgoing portion 3 and a return portion 4 which are substantially rectilinear and parallel, together with two semicircular portions running, respectively, around a driving return wheel 5 and an idle return wheel 6 whose respective axes 7 and 8 are substantially parallel. The driving wheel 5 is driven by a motor 9, in the direction indicated by the arrow in FIG. 1. The terms “upstream” and “downstream” are defined with respect to the direction of movement of the chain 2.

The motor 9 is, for example, an electric motor of any type (direct current, asynchronous, brushless, etc.). The acceleration and deceleration curves, the stopping precision and the nominal speeds are controlled by means of frequency-based speed controllers or axis cards, according to the motor technology which is chosen.

The two wheels 5 and 6 are placed on a support 10 which itself is fixed to a base 11 by legs 12. In the illustrated embodiment, the chains 2 are located in vertical planes, but this arrangement is not exhaustive.

In the vicinity of the support 10 there is a reel 13 of adhesive tape 14 mounted rotatably about the axis 15 of a support 16 fixed to the base 11. The axis 15 is substantially parallel to the planes of the chains 2 and orthogonal to the outgoing portion 3 and the return portion 4: consequently, the adhesive tape 14 is unwound in a plane substantially parallel to the planes of the chains 2 and along a trajectory substantially parallel to the outgoing portion 3.

The adhesive tape 14 can be neutral or can have marks (“spotted adhesive”). It can be intended to form a prepared handle, or to create a batch, etc. The width and length to which the piece is cut can vary according to the application concerned.

Two substantially identical grippers 17 are mounted on the two chains 2, symmetrically about the median axis 18, defined as the axis parallel to the axes 7 and 8 of the wheels 5 and 6 and located halfway between these. FIG. 1 shows the two grippers 17 in two different positions (in heavy lines and in fine lines). The grippers 17 are fixed to the two chains 2 and are therefore always rotated in the same direction.

Each gripper 17 comprises two substantially parallel rods 19 and 20 mounted in two separate links of each of the chains 2. In this case the rods 19 and 20 are orientated parallel to the axes 7 and 8 of the wheels 5 and 6, and inserted into the adjacent links of the same chain 2, as shown in FIG. 2.

Each gripper 17 has a first and a second branch 21 and 22 connected by the rods 19 and 20, between which branches the adhesive tape 14 is intended to be held in order to be pulled. The branches 21 and 22 extend substantially perpendicularly to the rods 19 and 20, and therefore parallel to the planes of the chains 2, toward the outside of the chains 2, and are positioned facing each other.

The first branch 21 is intended to come into contact with the adhesive side 23 of the adhesive tape 14. It is fixed with respect to the chains 2, in other words with respect to the rods 19 and 20. The first branch 21 comprises at least one roller 24 mounted rotatably about the principal axis 25 of said branch 21, orthogonally to the rods 19 and 20. This may take the form of a milled brass roller or idle wheels, depending in particular on the adhesive strength of the adhesive tape 14.

The second branch 22 is intended to come into contact with the smooth side 26 of the adhesive tape 14. It is mounted so as to be slidable along the rods 19 and 20 with respect to the first branch 21. One or more springs 27 are placed between the two branches 21 and 22, and push the second branch 22 toward its position remote from the first branch 21, in other words into the open position of the gripper 17. The second branch 22 is substantially parallelepipedal and comprises, facing the first branch 21, an element 28 made from flexible material (such as foam or polyurethane). The second branch 22 is also fitted with rollers 29 whose axes are substantially parallel to the principal axis 25 of the first branch 21.

A third rod 30, positioned substantially parallel to the rods 19 and 20, in the same plane and in the proximity of the rods, is engaged in another link of each of the chains, in this case in the links adjacent to those receiving one of the rods 19, 20. The third rod 30 acts as a supporting stay and ensures that the two chains 2 remain parallel.

The device 1 also comprises a system for causing the closure of the gripper 17 and for enabling it to open, at specified points of the chain 2. This system comprises, on the one hand, a fixed cam (not shown) positioned facing the outgoing portion 3 from an area called the gripping area 31, and, on the other hand, a moving cam 32 extending as a continuation of the fixed cam facing the outgoing portion 3, at least up to an area called the release area 33. The moving cam 32, driven by a pneumatic actuator, can be moved between a forward (default) position in which it is located substantially in the same plane as the fixed cam, and a retracted position. The cams are intended to interact with the rollers 29 of the gripper 17 when the latter moves on the outgoing portion 3. When the rollers 29 come into contact with the fixed cam, at the point where the gripper 17 is located in the gripping area 31 at the start of the outgoing portion 3, this causes the closure of the gripper 17. The gripper 17, which moves on the outgoing portion 3, is kept in the closed position along the whole length of the fixed cam. When the gripper 17 reaches the release area, in line with the moving cam 32, the latter can be moved toward its retracted position. Consequently, the moving cam 32 ceases to exert any closing force, and the gripper 17 opens under the action of the springs 27.

Finally, the device 1 comprises a cutting system 34 for cutting the pulled adhesive tape 14 to form therefrom a piece separate from the reel 13. The cutting system 34 is located in the proximity of the outgoing portion 3, on the trajectory of the pulling of the adhesive tape 14, immediately downstream of, and as near as possible to, the gripping area 31.

The cutting system 34 comprises, on the one hand, a cutting unit 35 positioned on the smooth side 26 of the pulled adhesive tape 14, having a transverse cutter 36. Pressure elements, namely an upstream element 37 and a downstream element 38, are positioned on either side of the cutter 36, for the adhesion of the adhesive tape 14 at the moment of cutting, as described below. The downstream pressure element 38 can be fitted with an element made from flexible material (such as foam or polyurethane). A pneumatic actuator 39 drives the cutting unit 35 to move it toward or away from the adhesive tape 14, the cutting unit 35 being by default in the retracted position, in other words remote from the adhesive tape 14.

The cutting system 34 comprises, on the other hand, an anvil unit 40 positioned on the adhesive side 23 of the pulled adhesive tape 14, having a transverse upstream finger 41 and a transverse downstream finger 42, spaced apart from each other and located facing the pressure elements 37 and 38 of the cutting unit 35. The anvil unit 40 has the function of keeping the adhesive tape 14 in tension at the moment of cutting, on either side of the cutter 36, by using the adhesive capacity of the adhesive tape 14. The upstream finger 41 is substantially parallelepipedal, while the downstream finger 42 comprises at least one roller 43 mounted rotatably about the principal axis of said downstream finger 42, positioned transversely. This arrangement can take the form of a milled brass roller or idle wheels. A pneumatic actuator 44 drives the anvil unit 40 to move it toward or away from the adhesive tape 14, the anvil system 40 being by default in the retracted position, in other words remote from the adhesive tape 14, in which position it frees the space required for the gripper 17 to pass between the cutting unit 35 and the anvil unit 40.

The operation of the device 1 will now be described.

In the initial starting position, the adhesive tape 14 is engaged in one of the two grippers 17 of the device 1, located in the gripping area 31, immediately before the cutting system 34. The action of the fixed cam keeps the gripper 17 in the closed position. The cutting unit 35 is in the retracted position, and the anvil unit 40 is in the forward position.

The anvil unit 40 is moved toward its retracted position, to allow the gripper 17 to pass. The gripper is moved (by the operation of the chains 2) along the outgoing portion 3 through a distance L matching the desired length of the piece of adhesive tape 14. The pulling of the adhesive tape 14 through a distance L is detected

either from the physical positioning of the components of the device 1, using an encoder associated with the drive means (for example, an incremental pulse supplied by an encoder fitted on the transmission shaft of the motor 9), or using a sensor placed in the release area and capable of detecting the position of the gripper 17. The position of this sensor on the outgoing portion 3 can be adjusted;

or by means of the marks 45 present on the adhesive tape 14 and detectable by a sensor which is fixed with respect to the reel 13.

The detection modes do not operate at the same time, one of them being chosen in advance by the control system.

When the gripper 17 reaches the desired position, it is stopped. The following operations are then performed simultaneously:

the closure of the anvil unit 40, which is brought into contact with the adhesive side 23 of the adhesive tape 14;

the movement of the cutting unit 35 to the forward position, the cutter 36 carrying out the cut and engaging in the space provided between the upstream finger 41 and the downstream finger 42 of the anvil unit 40, while the pressure elements 37 and 38 press the adhesive tape 14 onto the fingers 41 and 42 and keep it there.

Thus, the cut piece of adhesive tape 14 is held at its pulled end by the gripper 17 located in the release area 33, and at its other end by the downstream finger 42. The adhesive tape 14 being unwound from the reel 13 is held at its upstream end by the upstream finger 41. Since the upstream finger 41 is parallepipedal, it allows the adhesive tape 14 to adhere to a larger surface area than a cylindrical finger would, and therefore holds it better. Thus the adhesive tape 14 is always held at the reel end while awaiting the arrival of another gripper 17.

Since the adhesive tape 14 is constantly held, the device 1 can be placed in any position in space, as there is no risk of displacement of the adhesive tape due to gravity.

The gripper 17 is then opened by the movement of the moving cam 32 toward its retracted position. The adhesive tape 14 continues to be held at its pulled end by adhesion to the first branch 21.

The piece of adhesive tape 14 prepared in this way is then transferred toward a user station (not shown), in a direction substantially orthogonal to the plane of the pulled adhesive tape. During this movement, the adhesive tape 14 is easily detached from the gripper 17 and from the downstream finger 42 by rotating the roller or rollers 24 and 43 toward each other. It should be noted that, at the pulled end, the adhesive tape 14 is very firmly held on the first branch 21 of the gripper 17, because it has been strongly pressed onto the roller or rollers 24 by the crushing of the flexible element 28. The gripper 17 must therefore be opened to permit the detachment of the adhesive tape 14. At its upstream end, however, if the downstream pressure element 38 does not have a flexible element, the adhesive tape 14 adheres only weakly to the downstream finger 42 (along a generatrix overall), and therefore the anvil unit 35 does not have to be moved toward its retracted position to allow the release of the adhesive tape 14. The transfer can be carried out, for example, by an actuator system 46, positioned on the smooth side 26 of the adhesive tape 14 (see FIGS. 5 and 13). The pulling of the adhesive tape 14 is independent of the movement of the product or products to be fitted with said tape, and thus a more carefully controlled adhesion can be achieved when the products are stationary.

The chains 2 are then put into motion again, the grippers 17 therefore moving simultaneously to bring the gripper 17, which was waiting on the return portion 4, into the gripping area 31, while the gripper 17 which has just pulled the adhesive tape 14 is removed along the return portion 4. The stopping of the gripper 17 in the gripping area 31 is controlled by a detector cell. The gripper 17 closes in this movement, in contact with the fixed cam, immediately before the cutting system 34. The longitudinal distance between the anvil unit 40 and the start of the fixed cam is fixed. The adhesive tape 14 which has left the reel 13 is therefore now held in the gripper 17.

At the same time, the following operations are performed:

the anvil unit 40 and the cutting unit 35 are moved to the retracted position, to allow the free passage of the gripper 17;

the moving cam 32 is moved to the forward position, so that it can keep the adhesive tape 14 held in the gripper in the release area 33.

The device 1 is then in the initial state described above, and the pulling/cut-off/movement cycle of the grippers can be repeated.

The device 1 makes it possible to carry out 30 to 60 cuts per minute, the average time of one cycle being possibly about 0.65 seconds. The return of the gripper which has just pulled the adhesive tape takes place outside the cycle, since the other gripper is pulling the adhesive tape in its turn. The outgoing portion 3 determines the trajectory of the adhesive tape and the possible lengths of pull. This length can easily be adjusted by setting the position of the gripping area 31 and by providing a plurality of successive moving cams 32 as a continuation of the fixed cam. The release area 33 is thus positioned according to the active moving cam.

Reference will now be made to FIG. 13.

The device 1 is completed by specific arrangements on the unwinding path of the adhesive tape 14, with the following aims:

to reduce the elongation of the adhesive tape to a minimum, by limiting the tape pulling force to a position as near as possible to the gripping by the gripper and its pulling path;

to ensure a constant pull on the adhesive tape along the whole unwinding path, during both movement (pulling) and stoppage, to prevent the adhesive tape from folding or kinking during its unwinding.

These aims are achieved by interposing between the reel 13 and the device 1 a powered drum 47 supplemented by a tension maintaining block 48 located immediately next to the exit.

The powered drum 47 provides physical isolation between the reel unwinding lever 49 (driven in an oscillating way) and the device 1. It pulls the adhesive tape from the reel 13 and helps to lead the adhesive tape toward the gripper 17 on its activation. The powered drum 47 therefore receives the strongest pulling force related to the unwinding of the adhesive tape from the reel 13 (approximately twice the force measured between the drum and the gripper).

The blocks located on the unwinder (namely the reel 13 and the unwinder lever 49) and at the exit of the powered drum 47 enable the adhesive tape to be kept constantly under tension. Because of the activation gap between the primary pull and the secondary unwinding (due to inertia and the elongation of the adhesive tape), the block 48 at the exit of the powered drum 47 is the first element to oscillate.

Between the unwinder and the powered drum 47, the primary pull is provided by the drum, and the unwinding takes place in the unwinder (by rotation of the reel 13). Between the device 1 and the drum, the primary pull is provided by the gripper 17, the unwinding and the secondary pull being provided by the powered drum 47.

The pull on the adhesive tape 14 due to the movement of the gripper 17 on the chains 2 causes the block 48 at the exit of the powered drum 47 to oscillate, and uncovers the detection cell. The cessation of the detection of the block 48 then causes the powered drum 47 to be rotated. The pulling of the adhesive tape by the drum then makes the unwinder lever 49 oscillate and uncovers the detection cell. The cessation of the detection of the unwinder lever 49 then causes the release of the electromagnetic brake of the unwinder, thus allowing the reel 13 to rotate and allowing the adhesive tape 14 to unwind.

The pulling of the adhesive tape is therefore controlled by a sequencing of the different actuators. The reel 13 is stopped by the reverse reaction of each actuator, triggered by the stopping of the gripper 17 at the end of its travel on the outgoing portion 3, in other words in the release area 33.

Clearly, the invention is not limited to the embodiment described above by way of example, but includes all variant embodiments.

1. A device for preparing a piece of adhesive tape of desired length from a reel of adhesive tape, which comprises:
at least one endless conveying means, of the belt, chain or equivalent type, having an outgoing portion and a return portion, and capable of being driven in a loop by drive means;
at least one gripper mounted on the endless conveying means, having two branches, and being capable of taking up an open position, in which the branches are separated from each other, or a closed position, in which the branches are substantially adjacent and capable of holding the adhesive tape between them;
means for causing the closure of the gripper when the latter is located on the outgoing portion in a gripping area, so that the gripper can hold the adhesive tape unwound from the reel;
means for holding the gripper in the closed position when it moves on the outgoing portion, to enable the adhesive tape to be pulled substantially parallel to the outgoing portion;
means for causing the stopping of the endless conveying means when the gripper is located on the outgoing portion in a release area located downstream of the gripping area;
means for causing the opening of the gripper when the latter is located in said release area;
a cross-cutting system for the adhesive tape, located in the vicinity of the outgoing portion, downstream of the gripping area, and designed to be capable of holding the adhesive tape once the latter has been cut off, at least on the upstream side of the cutting system.

2. The device as claimed in claim 1, which comprises a fixed cam positioned facing the outgoing portion to cause the closure of the gripper in the gripping area and hold the gripper in the closed position over the whole length of said fixed cam, and a moving cam extending as a continuation of the fixed cam facing the outgoing portion, at least up to the release area, said moving cam being movable between a forward position, in which it holds the gripper in the closed position, and a retracted position, in which it allows the gripper to move to the open position.

3. The device as claimed in claim 2, wherein the gripper comprises resilient means positioned to push the branches of said gripper toward the open position and at least one roller which can interact with the fixed and moving cams to enable the gripper to close in opposition to said resilient means.

4. The device as claimed in claim 1, which comprises at least two grippers mounted on the endless conveying means, and substantially regularly distributed on the periphery of said endless conveying means.

5. The device as claimed in claim 1, wherein the branch intended to come into contact with the adhesive side of the adhesive tape is fixed with respect to the endless conveying means.

6. The device as claimed in claim 1, wherein the gripper is mounted on the endless conveying means in such a way that, when it pulls the adhesive tape, the latter is located in a plane substantially parallel to the plane of the endless conveying means.

7. The device as claimed in claim 1, which comprises two endless conveying means which are substantially identical, parallel and superimposed, and driven by the same drive means, the gripper being fixed to the two endless conveying means.

8. The device as claimed in claim 7, wherein each of the endless conveying means is formed by a chain and in that the gripper comprises two substantially parallel rods connecting the branches of said gripper, the rods being mounted in two separate links of each of the chains.

9. The device as claimed in claim 8, which comprises a third rod positioned substantially parallel to the rods of the gripper, in the same plane and in the proximity of these rods, said third rod being engaged in a third link of each of the chains.

10. The device as claimed in claim 1, wherein the branch of the gripper intended to come into contact with the adhesive side of the adhesive tape comprises at least one roller mounted rotatably about the principal axis of said branch.

11. The device as claimed in claim 1, wherein the branch of the gripper intended to come into contact with the smooth side of the adhesive tape comprises an element made from flexible material, facing the other branch.

12. The device as claimed in claim 1, wherein the cutting system is designed to hold the cut piece of adhesive tape on the downstream side of the cutting system.

13. The device according to claim 1, wherein the cutting system comprises:
a cutting unit positioned on one side of the plane of the pulled adhesive tape, having a cross-cutting tool upstream and downstream of which pressure elements are positioned;
an anvil unit positioned on the other side of the plane of the pulled adhesive tape, having an upstream finger and a downstream finger spaced apart from each other and located so that they face the pressure elements of the cutting unit;
the units being movable between:
a forward position, in which the cutting tool is engaged in the space provided between the upstream and downstream fingers of the anvil unit, and the adhesive tape, when cut off, can be held between said fingers and the pressure elements of the cutting unit;
and a retracted position, in which the units are separated from each other and from the plane of the pulled adhesive tape, so as to enable the gripper to move on the outgoing portion.

14. The device as claimed in claim 13, wherein the downstream finger of the anvil unit comprises at least one roller mounted rotatably about a transverse axis.

15. A method for preparing a piece of adhesive tape of desired length from a reel of adhesive tape, which comprises the steps of:
providing at least one endless conveying means, of the belt, chain or equivalent type, having an outgoing portion and a return portion, and capable of being driven in a loop by drive means;
providing at least one gripper mounted on the endless conveying means, having two branches, and being capable of taking up an open position, in which the branches are separated from each other, or a closed position, in which the branches are substantially adjacent and capable of holding the adhesive tape between them;
providing a system for cross-cutting the adhesive tape, located in the vicinity of the outgoing portion, downstream of the reel;
causing the closure of the gripper when the latter is located on the outgoing portion in a gripping area located upstream of the cutting system, so that the gripper can hold the adhesive tape unwound from the reel;
driving the endless conveying means, in order to move the gripper which is kept closed on the outgoing portion, and consequently to pull the adhesive tape substantially parallel to the outgoing portion;
detecting the fact that the adhesive tape has been pulled to the desired length and causing the gripper to stop in the corresponding position, in a release area located on the outgoing portion;
cutting the adhesive tape with the cutting system, and holding the adhesive tape cut in this way at least on the upstream side of the cutting system;
transferring the piece of adhesive tape prepared in this way toward a user station;
driving the endless conveying means, in order to return the gripper to the gripping area.

16. The method as claimed in claim 15, wherein the operation of detecting the pulled length of the adhesive tape is carried out by means of an encoder associated with the drive means or a sensor placed in the release zone and capable of detecting the position of the gripper, or a sensor fixed with respect to the reel and capable of detecting a mark present on the adhesive tape.

17. The method as claimed in claim 15, wherein, in the cutting step, the cut adhesive tape is also held on the downstream side of the cutting system.

18. The method as claimed in claim 15, wherein the prepared piece of adhesive tape is transferred toward a user station in a direction substantially orthogonal to the plane of the pulled adhesive tape.
